(19) United States
(12) Patent Application Publication
(10) Pub. No.: US 2009/0309436 A1
(43) Pub. Date: Dec. 17, 2009

(54) FLAT VIBRATION MOTOR

(75) Inventors: Koichiro SAITO, Ueda-shi (JP); Naoki Kanai, Ueda-shi (JP)

Correspondence Address: KRATZ, QUINTOS & HANSON, LLP, 1420 K Street, N.W., Suite 400, WASHINGTON, DC, 20005, US

(73) Assignees: SANYO SEIMITSU CO., LTD., Nagano-ken (JP); SANYO ELECTRIC CO., LTD., Moriguchi-shi (JP)

(21) Appl. No.: 12/481,863

(22) Filed: Jun. 10, 2009

(30) Foreign Application Priority Data
Jun. 17, 2008 (JP) 2008-157681

(51) Int. Cl. H02K 7/075

(52) U.S. Cl. 310/81

(57) ABSTRACT

A flat vibration motor including a stator having a spindle for mounting a flexible substrate, and a rotor having an eccentric weight and rotatably supported by the spindle, the flexible substrate having a lower surface substrate overlapped on the lower surface of the stator and centered around the spindle, an upper surface substrate overlapped on the upper surface of the stator plate, and a narrow-width connecting part for connecting the lower surface substrate and the upper surface substrate by bending the lower surface substrate and the upper surface substrate in an integrated fashion at a notch in the circumference of the stator plate, and the upper surface substrate having a through hole for fastening and connecting an upper surface wiring pattern with the stator plate by filing solder bump, whereby reflow soldering in automatic mounting of a printed circuit of instrument side can be performed.

### CROSS REFERENCE TO RELATED APPLICATION

The present invention contains subject matter related to Japanese Patent Application No. 2008-157681, filed in the Japan Patent Office on Jun. 17, 2008, the entire contents of which being incorporated herein by reference.

### BACKGROUND OF THE INVENTION

1. Field of the Invention

The present invention relates to a so-called coin shaped flat vibration motor including a brushless motor or the like.

2. Description of the Related Art

Japanese Patent Publication (A) No. 10-262352 discloses, in its FIG. 2, a flat vibration motor having a power feeding structure with a power feeding flexible substrate bonded on the upper surface of a stator plate (bottom plate), the flexible substrate having a power feeding electrode which is bent at a terminal receiving part projected articulately from a part of the stator plate and is bonded on the back surface of the terminal receiving part.

The above-mentioned power feeding structure has the following problems. First, while the power feeding electrode is exposed to the three directions, i.e., to the upper surface, to the lower surface, and to the side surface, so as to enclose the terminal receiving part, however, the bonding area is so small that the power feeding structure cannot be applied to a case when it is fixed to a print circuit board of an instrument side by reflow soldering in automatic implementation. Second, the stator plate having the terminal receiving part projected articulately must be used so that the area occupied by the print circuit board of the instrument side is wasted.

### SUMMARY OF THE INVENTION

In view of the above problems, a first object of the present invention is to provide a flat vibration motor which can be bonded to the print circuit board of the instrument side by reflow soldering in automatic implementation. A second object of the present invention is to provide a flat vibration motor which can save the area occupied by the print circuit board of the instrument side.

To attain the above objects, according to the present invention, there is provided a flat vibration motor comprising a stator plate made of metal and having a spindle, for mounting a power feeding flexible substrate, and a rotor having an eccentric weight and rotatably supported by the spindle, wherein the power feeding flexible substrate comprises: a lower surface substrate overlapped on the lower surface of the stator plate and centered around the spindle; an upper surface substrate overlapped on the upper surface of the stator plate; and a narrow-width connecting part for connecting the lower surface substrate and the upper surface substrate by bending the lower surface substrate and the upper surface substrate in an integrated fashion at a notch in the circumference of the stator plate; the upper surface substrate having a through hole for fastening and connecting an upper surface wiring pattern and the stator plate by filing solder bump; and the lower surface substrate having a power feeding fastening pattern.

Since the power feeding flexible substrate is made of one body and has the lower surface substrate overlapped on the lower surface of the stator plate and centered around the spindle, since the lower surface substrate has the power feeding fastening pattern, and since the upper surface substrate overlapped on the upper surface of the stator plate has the through hole for fastening and connecting an upper surface wiring pattern and the stator plate by filing solder bump, not only the power feeding fastening pattern of the lower surface substrate but also a part of the lower surface can be used as a power feeding fastening region, so that a sufficient fastening area can be ensured and the flat vibration motor suitable for reflow soldering can be provided. In addition, the space occupied by the printed circuit board at the instrument side can be saved because it becomes unnecessary for the stator plate to have the part projected articulately. Further, since the upper surface substrate has the through hole for fastening and connecting the upper surface wiring pattern and the stator plate by filing the solder bump in the through hole, and since a part of the lower surface substrate has the power feeding fastening region which is not a mere fastening region without the power feeding fastening region, it becomes possible to increase the number of, for example, braking terminals for stopping the drive of the motor.

The stator plate preferably includes, in its lower surface, a concave part for accommodating the lower surface substrate, and a fastening circumference part for surrounding the concave part. The fastening circumference part may be the above-mentioned power feeding fastening region which is connected to a wiring pattern of a printed circuit board of the instrument side by the filled solder bump.

The power feeding fastening pattern includes a power feeding center fastening pattern and a circumferential power feeding pattern surrounding the power feeding center fastening pattern except for the position of the narrow-width connecting part, whereby, positioning errors, which may occur by reflow soldering for automatic mounting is carried out, can be reduced.

A solder reservoir groove is formed between the outer circumferential edge of the lower surface substrate and the inner circumferential edge of the fastening circumference part, whereby, excessive solder derived from the reflow soldering can be accommodated in the solder reservoir groove, and in addition, the fastening strength can be increased.

According to the present invention, it is possible to carry out reflow soldering in automatic mounting of a printed circuit of instrument side, and in addition, it is possible to save an occupation area of a printed circuit board of instrument side.

### BRIEF DESCRIPTION OF THE DRAWINGS

These and other objects and features of the present invention will become clearer from the following description of the preferred embodiment given with reference to the attached drawings, wherein:

FIG. 1A is a plan view illustrating a flat vibration motor according to an embodiment of the present invention;

FIG. 1B is a cross-sectional view when viewed along the line B-B′ in FIG. 1A;

FIG. 2 is a plan view illustrating s power feeding flexible substrate used in the flat vibration motor;

FIG. 3A is bottom view of the flat vibration motor;

FIG. 3B is bottom view illustrating a stator plate of the flat vibration motor; and

FIG. 4 is cross-sectional view of stator of the flat vibration motor.

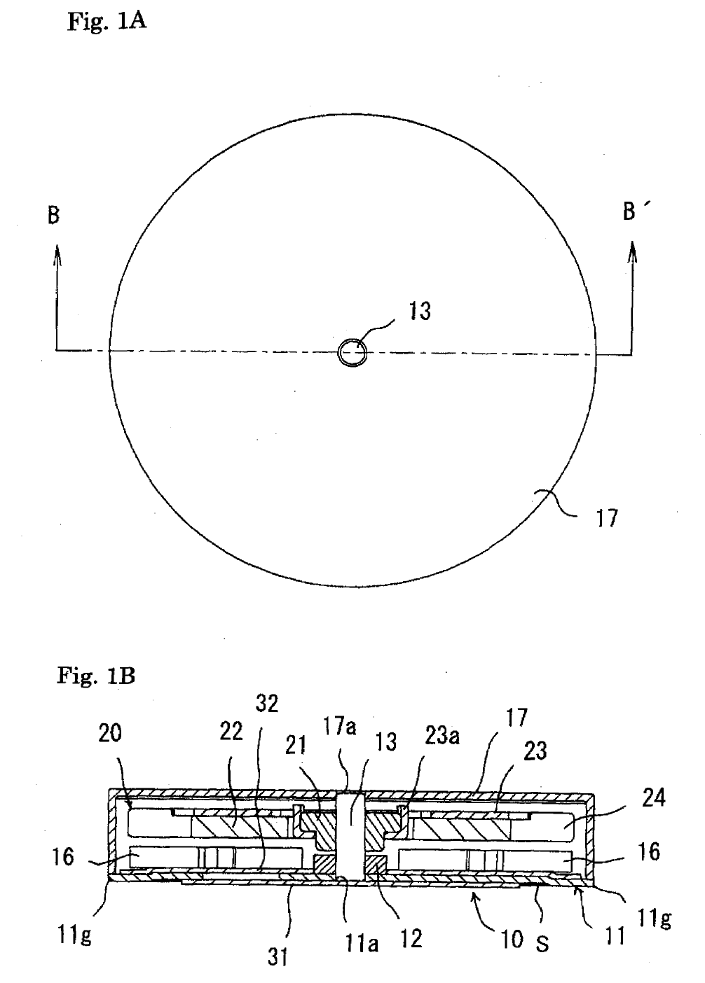

### DESCRIPTION OF THE PREFERRED EMBODIMENTS

Next, an embodiment of the present invention will be described with reference to the attached drawings. A flat (coin-shaped) vibration motor according to the embodiment of the present invention is a blushless motor including a stator 10 and a rotor 20. The stator 10 has a circular stator plate (a base plate or a bottom plate) 11 made of metal, a spindle (fix axis) 13 having an end fitted by welding into a center hole 11a of the stator plate 11, a washer 12 fitted to the spindle 13, a power feeding flexible substrate 30 overlapped on and thermally bonded to the upper surface of the stator plate 11, a switching integrated circuit 14 including a hole element for detecting the position of the rotation, and a capacitor 15. The switching integrated circuit 14 and the capacitor 15 are mounted on the flexible substrate 30. The stator 10 further has two flat air core magnetizing coils 16, 16 arranged on the power feeding flexible substrate 30, and a metal cover shaped as a shallow cup, fitted to the stator plate 11, having a center hole 17a into which the other end of the spindle 13 is pressed.

The rotor 20 is rotatably supported by the spindle 13 through a metal bearing 21 of a bearing holder part 23a. The rotor 20 has a rotor plate 23 having, on its lower side, a permanent magnet 22 with circularly-arranged six poles and faced to the flat air core coils 16, 16, and has an arc-shaped eccentric weight 24 provided at the outer periphery of the rotor plate 23.

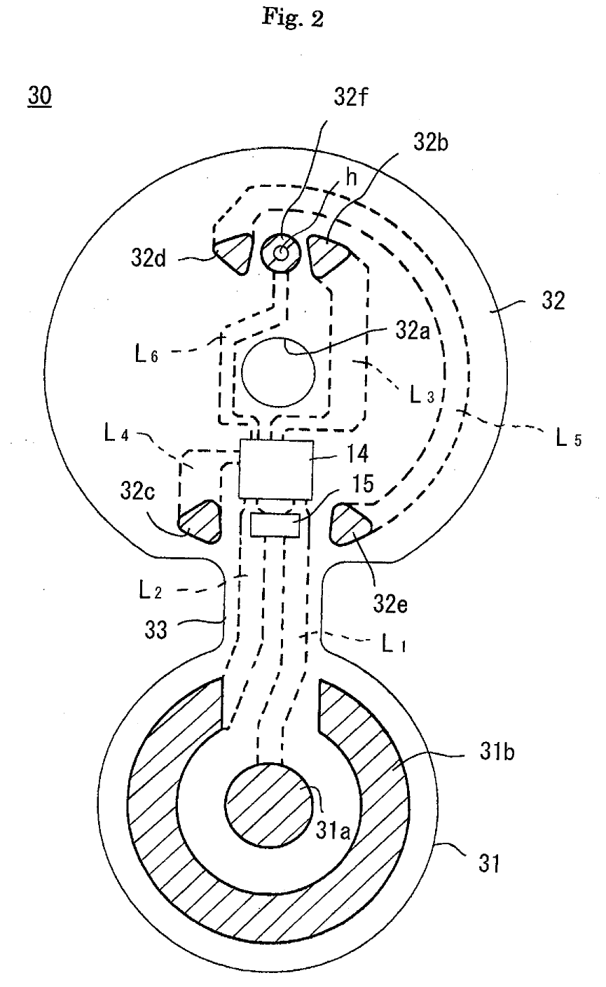

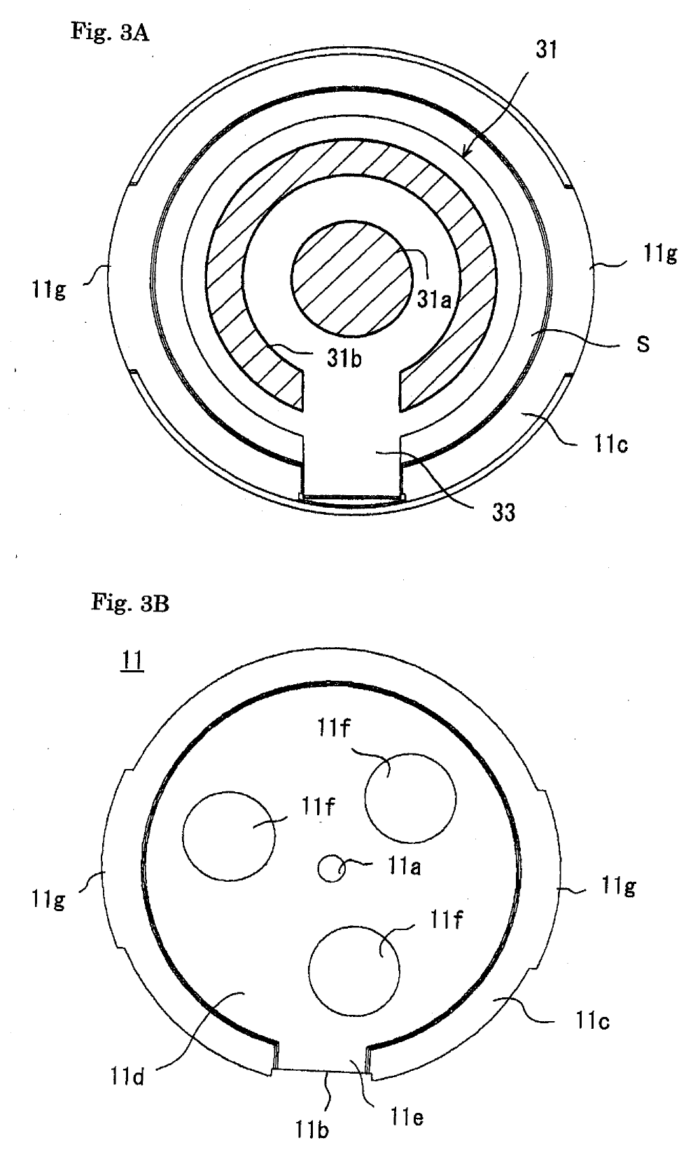

The power feeding flexible substrate 30 has its one side surface with a substrate of an electrically conductive layer. The power feeding flexible substrate 30 includes, as shown in FIG. 2, a lower surface substrate 31 shaped as a circular disk and overlapped on the lower surface of the stator plate 11 and centered around the center hole 11a, an upper surface substrate 32 shaped as a circular disk and overlapped on the upper surface of the stator plate 11, and a narrow-width connecting part 33 for connecting the lower surface substrate 31 and the upper surface substrate 32 by bending the lower surface substrate 31 and the upper surface substrate 32 in an integrated fashion at a notch 11b (see FIG. 3B) in the circumference of the stator plate 11. The lower surface substrate 31 includes a power feeding center fastening pattern 31a and a circumferential power feeding pattern 31b circularly surrounding, concentrically, the power feeding center fastening pattern 31a except for the area of the narrow-width connecting part 33. A power feeding wiring L₁ derived from the power feeding center fastening pattern 31a and a power feeding wiring L₂ derived from one end of the circumferential power feeding pattern 31b pass on the narrow-width connecting part 33 and are led to a pattern (not shown in the figures) for fixing a terminal of the switching integrated circuit 14 positioned between the center hole 32a which is fitted to the washer 12 on the upper surface substrate 32 and the side of the narrow-width connecting part 33. From the pattern for fixing the terminal, a power feeding wiring L₃ to be connected to a pattern 31b for fixing an end of the first flat air core magnetizing coil 16 (not shown in FIG. 2) and a power feeding wiring L₄ to be connected to a pattern 32c for fixing an end of the second flat air core magnetizing coil 16 (not shown in FIG. 2) are derived. In addition, a power feeding wiring L5 is formed to connect a pattern 32d for fixing an another end of the first flat air core magnetizing coil 16 (not shown in FIG. 2) with a pattern 32e for fixing an another end of the second flat air core magnetizing coil 16 (not shown in FIG. 2). The upper surface substrate 32 has a power feeding wiring L₆ derived from a land 32f having a through hole h. The power feeding wiring L₆ is led to a pattern (not shown in the figures) for fixing a terminal of the switching integrated circuit 14.

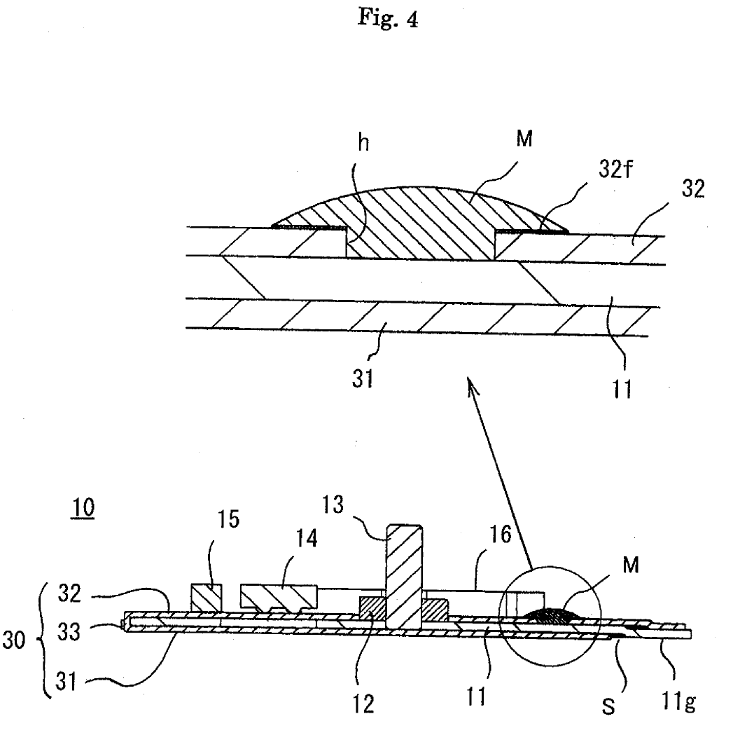

The stator plate 11 is a press-molded magnetic plate made of iron or the like. The lower surface (bottom surface) has a circular concave part 11d for accommodating the lower surface substrate 31 in an inner area of a fastening circumference part Tic. The circular concave part 11d is sagged downwards by the thickness of the substrate so that the surface level of the lower surface substrate 31 becomes the same as the surface level of the fastening circumference part 11c, thereby, it becomes easy to mount the vibration motor on a printed circuit board of the instrument side because the mounting surface is flat. From the circular concave part 11d to the notch 11b is a narrowed concave portion 11e having the same surface level as the circular concave part 11d so as to accommodate the narrow-width connecting part 33. The lower surface substrate 31 is overlapped on the surface within the circular concave part 11d by thermal adhesion. As shown in FIG. 3A, a solder reservoir groove S for is formed between the outer circumferential edge of the lower surface substrate 31 and the inner circumferential edge of the fastening circumference part 11c. As shown in FIG. 4, solder is filled in the through hole h of the land 32f of the upper surface substrate 32 to form solder bump M for fastening and connecting the land 32f with the stator plate 11.

As shown in FIG. 3B, in the area of the circular concave part 11d, circular holes 11f for generating cogging are formed at every 120 degrees with equal intervals and with a central hole 11a as its center. The fastening circumference part 11c has a projected piece 11g for receiving and engaging the bottom edge of the cover 17.

As shown in FIG. 3B, in the area of the circular concave part 11d, circular holes 11f for generating cogging are formed at every 120 degrees with equal intervals and with a central hole 11a as their center. The fastening circumference part 11c has a projected piece 11g for receiving and engaging the bottom edge of the cover 17.

As described above, according to this embodiment, since the power feeding flexible substrate 30 is made of one plate and has the lower surface substrate 31 overlapped on the lower surface of the stator plate 11 and centered around the spindle 13, since the lower surface substrate 31 has the power feeding fastening pattern 31a and the circumferential power feeding pattern 31b for applying the driving power supply voltage and the braking power supply voltage for stopping to drive and for reverse rotation to the switching integrated circuit 14, and since the upper surface substrate 32 has the through hole h filled with the solder bump M for fastening and connecting the land 32f with the stator plate 11, the fastening circumference part 11 of the stator plate 11 can be used as the power feeding fastening region, so that a sufficient fastening area can be ensured and the flat vibration motor suitable for reflow soldering can be provided. In addition, the space occupied by the printed circuit board at the instrument side can be saved because it becomes unnecessary for the stator plate 11 to have the part projected articulately. Further, since the fastening circumference part 11c can be used as a ground line GND, and since either one of the power feeding center fastening pattern 31a and the circumferential power feeding pattern 31b can be used as a braking terminal for reverse rotation of the motor when the drive of the motor is to be stopped, a three-terminal blushless motor can be used to suppress an inertia which is generated when the drive of the motor is stopped so as to stop the vibration quickly.

In addition, by forming the power feeding center fastening pattern 31a and the circumferential power feeding pattern 31b in a bull s-eye pattern on the printed circuit board of the instrument side, positioning errors, which may occur by reflow soldering for automatic mounting is carried out, can be reduced. Further, since the solder reservoir groove S is formed between the outer circumferential edge of the lower surface substrate 31 and the inner circumferential edge of the fastening circumference part 11c, excessive solder derived from the reflow soldering can be accommodated in the solder reservoir groove S, and in addition, the fastening strength can be increased.

1. A flat vibration motor comprising a stator plate made of metal and having a spindle, for mounting a power feeding flexible substrate, and a rotor having an eccentric weight and rotatably supported by said spindle, wherein
said power feeding flexible substrate comprises:
a lower surface substrate overlapped on the lower surface of said stator plate and centered around said spindle;
an upper surface substrate overlapped on the upper surface of said stator plate; and
a narrow-width connecting part for connecting said lower surface substrate and said upper surface substrate by bending said lower surface substrate and said upper surface substrate in an integrated fashion at a notch in the circumference of said stator plate;
said upper surface substrate having a through hole for fastening and connecting an upper surface wiring pattern with said stator plate by filing solder bump; and
said lower surface substrate having a power feeding fastening pattern.

2. The flat vibration motor as claimed in claim 1, wherein said stator plate comprises, in said lower surface, a concave part for accommodating said lower surface substrate, and a fastening circumference part for surrounding said concave part.

3. The flat vibration motor as claimed in claim 1, wherein said power feeding fastening pattern comprises a power feeding center fastening pattern and a circumferential power feeding pattern surrounding said power feeding center fastening pattern except for the area of said narrow-width connecting part.

4. The flat vibration motor as claimed in claim 3, wherein a solder reservoir groove is formed between the outer circumferential edge of said lower surface substrate and the inner circumferential edge of said fastening circumference part.
